(19) United States
(12) Patent Application Publication
(10) Pub. No.: US 2017/0177395 A1
(43) Pub. Date: Jun. 22, 2017

(54) EMBEDDED ARCHITECTURE BASED ON PROCESS VIRTUAL MACHINE

(71) Applicants: Mingqiu Sun, Beaverton, OR (US); Vincent J. Zimmer, Federal Way, WA (US); Rajesh Poornachandran, Portland, OR (US); Gopinatth Selvaraje, Portland, OR (US)

(72) Inventors: Mingqiu Sun, Beaverton, OR (US); Vincent J. Zimmer, Federal Way, WA (US); Rajesh Poornachandran, Portland, OR (US); Gopinatth Selvaraje, Portland, OR (US)

(21) Appl. No.: 14/976,936

(22) Filed: Dec. 21, 2015

(51) Int. Cl. G06F 9/455; G06F 9/50

(52) U.S. Cl. CPC G06F 9/45558; G06F 9/5038; G06F 2009/4557

(57) ABSTRACT

A system on a chip (SoC) may comprise at least one processor with at least one core and a storage device comprising a first system virtual machine configured to be executed on the at least one processor. The storage device may comprise a second system virtual machine configured to be executed by the at least one processor. The second system virtual machine may include at least one process virtual machine; a modem configured as one of the at least one process virtual machine; and a real-time operating system (RTOS) to schedule execution of the at least one process virtual machine on the at least one processor.

### TECHNICAL FIELD

Embodiments described herein generally relate to system architecture and in particular, but without limitation, to embedded architecture based on process virtual machine.

### BACKGROUND

A system-on-a-chip, or SoC, is a single integrated circuit that includes the components (e.g., microprocessor, memory, input/output logic) for a particular system. An SoC may be useful when power usage is a concern such as in IoT devices and smartphones.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates a software architecture for a System on a Chip (SoC), according to various examples.

FIG. 2 illustrates a software architecture for an SoC, according to various examples.

FIG. 3 illustrates a schematic diagram of a modem module, according to various examples;

FIG. 4 illustrates a runtime for loading a modem module, according to various examples;

FIG. 5 illustrates a flowchart of a method of executing virtual machines on a system on a chip, according to various examples; and

FIG. 6 is a block diagram illustrating an example machine upon which any one or more of the techniques (e.g., methodologies) discussed herein may be performed, according to an example embodiment.

### DETAILED DESCRIPTION

In various examples, a system-on-a-chip, or SoC, is a single integrated circuit that includes the components (e.g., microprocessor, memory, input/output logic) for a particular system. An SoC may be useful when power usage is a concern such in IoT devices and smartphones; however, SoCs are not limited to such uses and are increasingly used in higher-end computing devices. For convenience, this disclosure generally discusses an SoC as it pertains to a mobile device with a cellular modem.

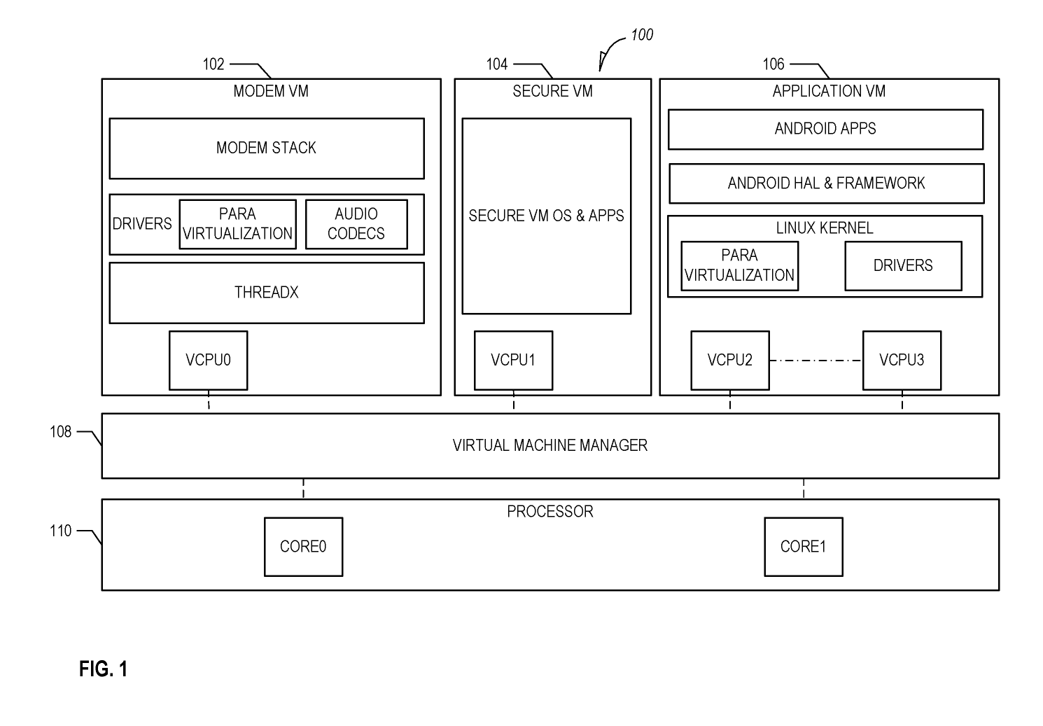

FIG. 1 illustrates a software architecture for an SoC, according to various examples. The software architecture includes multiple system virtual machines (VMs): modem VM 102, secure VM 104, and application VM 106. The software architecture further includes virtual machine manager 108 and processor 110. The processor 110 may include more than one core in various examples. In an example, modem VM 102 may be used to transmit/receive data over one or more cellular antennas. The secure VM 104 may be used for security functions running on the SoC that are to be isolated from user applications executing on application VM 106.

A system VM may be a platform that allows execution of other processes (e.g., applications) via a guest operating system. The host and guest operating systems may be different or the same. For example, the host operating system may be Linux based, but the guest operating system may be Microsoft Windows® variant. The guest operating system may provide a complete system for the execution of applications, etc., created for the guest operating system. In other words, a system VM may include drivers, libraries, etc., that would regularly exist if the guest operating system was the main operating system of a computing device.

An application running via a system VM would appear to have access to the processor(s) of the computing device but in actuality would be implemented as virtual processors—such as VCPU0 in modem VM 102. In some instances, a system VM uses resources of the host computing device regardless of whether an application is running on the system VM.

Manufacturers of SoCs are presented with a variety of challenges when potential customers want to add dedicated functionality beyond that provided in modem VM 102, secure VM 104, and application VM 106. For example, some customers may want a dedicated system VM for processing sensor input on a smartphone. Another dedicated system VM may be used to listen for audio at all times, while another system VM processes location information. The performance of an SoC may be negatively impacted when utilizing this many system VMs due to the overhead requirements of each system VM.

Scheduling becomes another challenge when using multiple system VMs (e.g., via virtual machine manager 108). Many VMs may create producer-consumer pair problems such as modem VM 102 receiving/sending data that application VM 106 is also processing. Because the same physical processors (e.g., processor 110) may be exposed to the same system VMs, both VMs may try to preempt the other VM leading to significant performance and user experience problems.

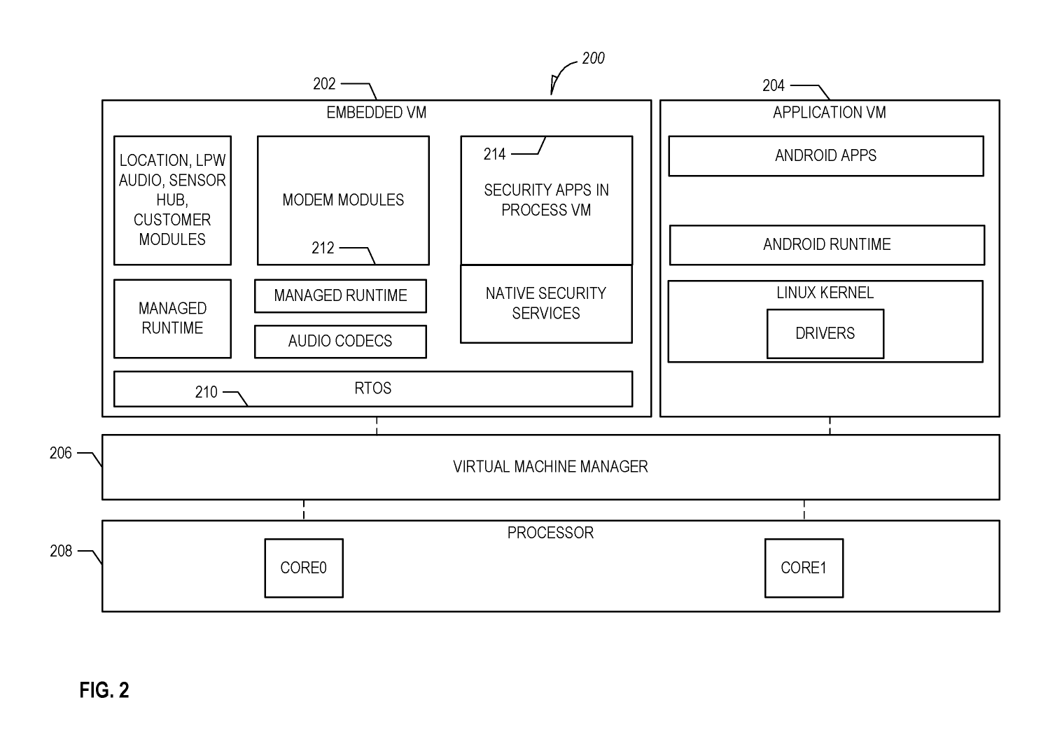

FIG. 2 illustrates a software architecture 200 for an SoC, in various examples. In contrast to FIG. 1, the software architecture 200 includes only two system VMs: embedded VM 202 and application VM 204. The embedded VM 202 may include at least one process VM such as modem modules 212 and security apps 214. The security apps may run on top of a process virtual machine, which may interface with native security services. In an example, a real-time operating system (RTOS) 210 is used as the guest operating system for embedded VM 202. The software architecture 200 also includes virtual machine manager 206.

Application VM 204 may include the operating system as used by an end user. For example, in application VM 204 a Linux kernel is included in addition to an Android Run Time. Android Apps may be executed using the Android Run Time. As in FIG. 1, the application VM 204 is separated from security apps 214 and modem modules 212. In an example, different embedded process virtual machines may be implemented on a common managed runtime infrastructure to minimize system footprint.

In contrast to system VMs, a process VM may be executed via a host operating system and may act as a regular application would on the host operating system. However, the process VM may include the resources necessary to run a specific application and nothing more. In other words, the resource overhead for a process VM may be considerably less than a system VM, which includes an entire guest operating system.

A managed runtime environment may support the execution of a process VM via a host operating system. The runtime may abstract away many of the specifics of the underlying host operating system. In an example, the runtime environment handles many of the generic tasks that the developers used to have to anticipate and build in. For example, a managed runtime may handle heap management, security, class loading, garbage collection, and memory allocation, which may allow developers to concentrate on the business logic specific to their applications.

As seen, FIG. 2 illustrates a marked change from the software architecture of FIG. 1. Both modem and security apps were system level VMs in FIG. 1 but are process VMs in FIG. 2, (e.g., modem modules 212 and security apps 214). Furthermore, the other system VMs in FIG. 1 (e.g., sensor hub, not shown in FIG. 1) are process VMs within embedded VM 202.

Using the process VMs instead of system VMs helps to overcome a number of the challenges described above with respect to use of a software architecture as in FIG. 1. For example, the consumer-producer problem may be significantly reduced due to the number of system VMs matching the number of cores of processor 208 and each VM may be scheduled on a separate core. In contrast, there are many more system VMs than available cores for scheduling in FIG. 1, which may lead to performance issues as the VMs fight for access to the processing cores.

With reference back to FIG. 2, RTOS 210 may be used for scheduling the individual process VMs on processor 208. Furthermore, RTOS 210 may be used to isolate execution of a process VM from other process VMs.

Each process VM may be scheduled based on priority levels of a process VM. The priority level may be set by the RTOS or dynamically provisioned. For example, assuming that the SoC is part of a mobile phone, a software update may be installed that updates the priority level of a specific process VM. The process VMs may be dynamically provisioned overtime—either at creation of the SoC or after the SoC is in the hands of an end user.

The priority level may be changed during execution of one or more VMs. For example, the priority level of a sensor hub process VM may begin low but if the sensor process VM has not been run for a certain period of time, the priority level may increase. In another example, if a process VM is responsible for processing audio input, the priority level may be low if there is no detected noise, but increase when noise above a certain threshold is detected.

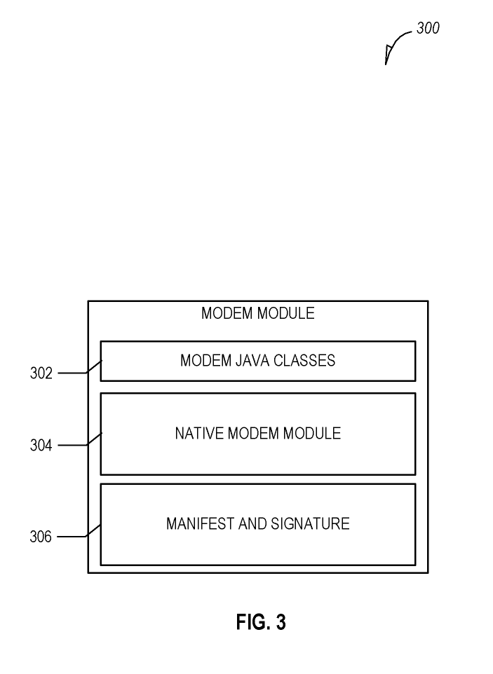

FIG. 3 illustrates a schematic diagram of a modem module 300, according to various examples. The modem module 300 may be transmitted to update an existing modem module in modem modules 212 or create a new modem module. The modem module 300 includes modem Java classes 302, native modem module 304, and manifest and signature portion 306.

The modem Java classes 302 may be the code used by applications in order to access functionality of the modem. The native modem module 304 may be the actual communication primitives (e.g., transmit/receive) for the modem according to one or more communication standards.

In an example, the manifest and signature portion 306 includes attribution information. The manifest and signature portion 306 may include a hash of modem Java classes 302 and native modem module 304 encrypted with a private key of the sender. The manifest and signature portion 306 may also include the public key of the sender.

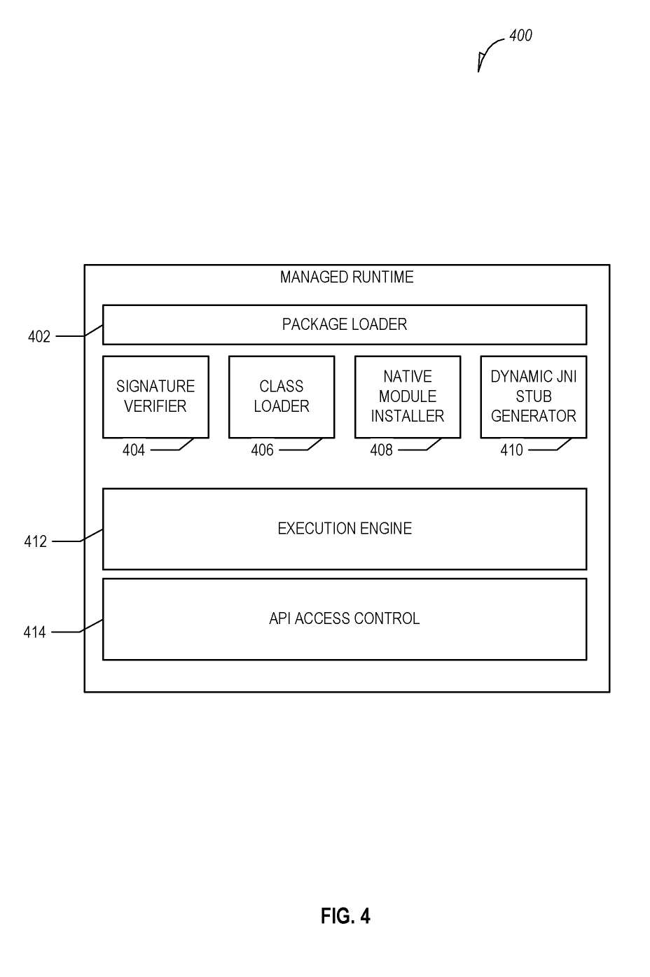

FIG. 4 illustrates a runtime 400 for loading a modem module, according to an example embodiment. The runtime may be a process VM within embedded VM 202. The runtime 400 may include package loader 402, signature verifier 404, class loader 406, native module loader 408, dynamic Java Native Interface (JNI) stub generator 410, execution engine 412, and API access control 414.

The package loader 402 may be used to parse modem module 300. Parsing may include accessing manifest and signature portion 306 to identify what sections are supposed to be present in modem module 300. In some example, not all modem modules include both modem Java classes 302 and native modem module 304. There may be instances where only modem Java classes 302 or native modem module 304 is updated. If the manifest and signature portion 306 indicates both sections are included, but package loader 402 only sees one section, the modem module may be rejected.

The signature verifier 404 may be used to verify the sender of modem 300. Verification may include using the included public key to decrypt the hash. Signature verifier 404 may independently compute a hash of the included data (e.g., modem Java classes 302 and native modem module 304). If the computed hash matches the decrypted hash, the modem may be considered authentic. In an example, the public key is compared to a trusted repository of keys either on the device the SoC is part of or retrieved from an external source.

The class loader 406 and native module loader 408 may be used to update—or install if no modem is already present—the classes and communication primitives using execution engine 412. Updating/installing may include modifying data stored on a storage device communicatively coupled to the SoC or on the SoC itself.

The manifest and signature portion 306 may indicate the type of modem represented by modem Java classes 302 and native modem module 304. The class loader 406 and native module loader 408 may use this information to determine if a modem already exists within modem modules 212. For example, embedded VM 202 may include a datafile of installed process VMs and version information if available. Installing may include updating/adding resources files contained with modem modules 212 specific to the modem identified in modem modules 300. API access control 414 may be used to set limits on which processes/application have access to issue calls to control the modem.

The manifest may also include what versions of modem Java classes 302 and native modem module 304 are included. Accordingly, class loader 406 may examine the current version numbers (if any) of classes in a matching modem module to determine if an update is warranted Similarly, native module loader 408 may determine if the included communication primitives are newer than what is currently in modem modules 212.

In an example, dynamic JNI stub generator 410 is used to generate code stubs for use by a native operating system of embedded VM 202 with respect to the modem.

Although updating/installing modems was discussed in FIG. 3 and FIG. 4, software architecture of FIG. 2 is not so limited. For example, a new feature (e.g., a low power mode audio listening mode) of a mobile phone may be loaded after the SoC was produced. To add the new feature, a datafile may be transmitted to the hosing device. The datafile may include the code to run via a runtime in embedded VM 202. The datafile may also include a suggested priority level for the feature.

As with the modem module 300, a manifest and signature section may be used to parse the datafile and determine its authenticity. Also, before installing the feature, a check may be made to see if a process VM already exists for the feature.

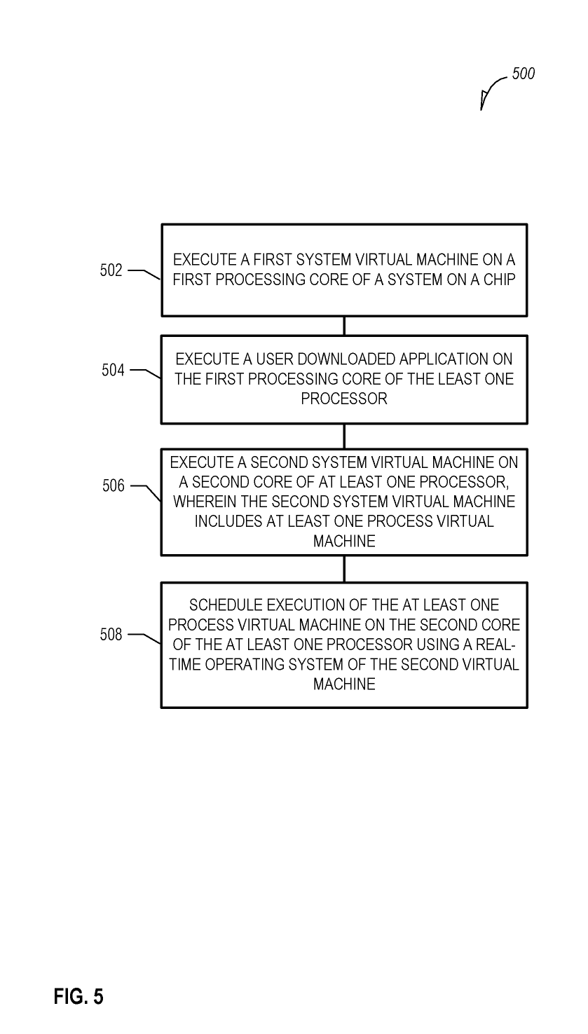

FIG. 5 illustrates a flowchart of a method of executing virtual machines on a system on a chip, according to various examples. The method may be performed by the SoC described herein. At operation 502, a first system virtual machine is executed on a first processing core of the system on a chip. At operation 504, in an example, a user downloaded application is executed on the first processing core of the least one processor. For example, a the SoC may be part of a mobile phone. The user may download an application from an app store. The application may be executed using the first virtual machine using a runtime configured to execute the application on the first processing core.

At operation 506, in an example, a second system virtual machine is executed on a second core of at least one processor. The second system virtual machine may include at least one process virtual machine. In an example, a modem is configure as one of the process virtual machines. The SoC may be receive a datafile including an update to the modem. The datafile may also include a signature portion. The second system virtual machine may verify the authenticity of the datafile based on the signature portion.

The datafile may be part of an update to a mobile device that includes that SoC. The update may be transmitted to the mobile device from a carrier of the mobile device. The datafile may include data representing communication primitives (e.g., transmit/receive) for the modem. The modem may be updated based on the data.

In an example, a datafile may be received representing a feature of a mobile device. It may be determined that the feature is not already configured on the second system virtual machine a new process virtual machine may be established for the feature. Establishing may include configuring a managed runtime to execute code included in the datafile.

In an example, the datafile includes an update to an existing feature. The process virtual machine representing the feature may be updated based on data included in the datafile.

At operation 508, execution of the at least one process virtual machine on the second core of the at least one processor is scheduled using a real-time operating system of the second virtual machine. The scheduling may be based on priority levels of individual process virtual machines.

### Example Computer System

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

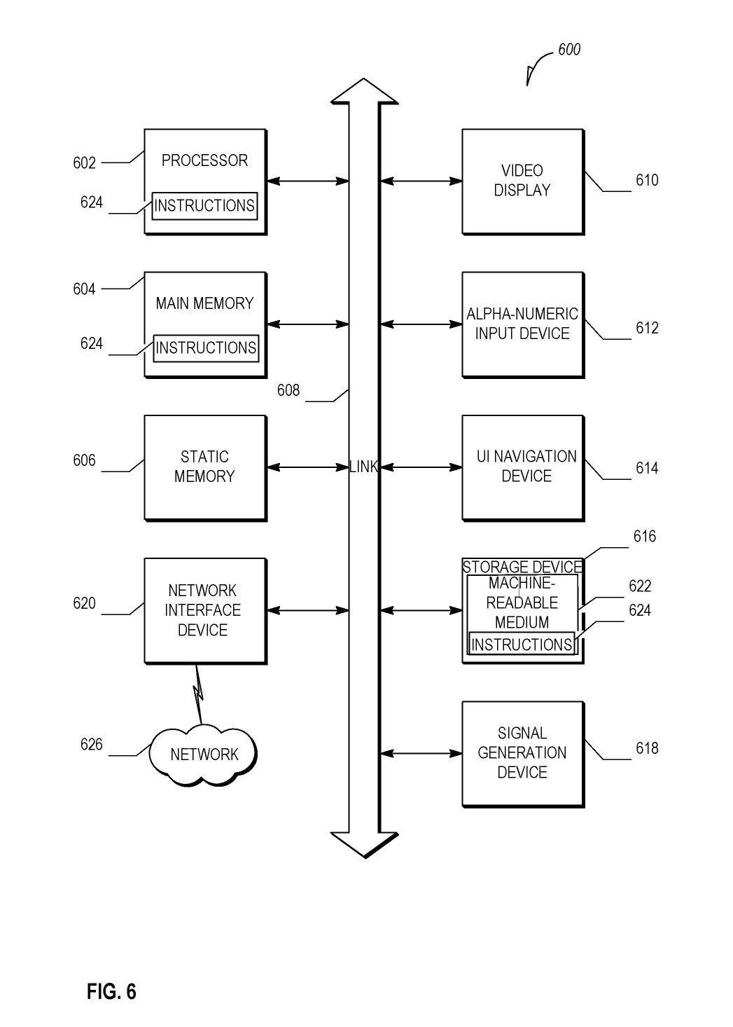

FIG. 6 is a block diagram illustrating a machine in the example form of a computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 6G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Example 1 is a system on a chip (SoC) for executing virtual machines, the SoC comprising: at least one processor with at least one core; and a storage device comprising a first system virtual machine configured to be executed on the at least one processor; wherein the storage device further comprises a second system virtual machine configured to be executed by the at least one processor, the second system virtual machine including: at least one process virtual machine; a modem configured as one of the at least one process virtual machine; and a real-time operating system (RTOS) to schedule execution of the at least one process virtual machine on the at least one processor.

In Example 2, the subject matter of Example 1 optionally includes, wherein the at least one processor is configured, when executing the second system virtual machine, to: receive a datafile including an update to the modem; and update communication primitives of the modem based on data received in the datafile.

In Example 3, the subject matter of Example 2 optionally includes, wherein the datafile comprises a signature portion.

In Example 4, the subject matter of Example 3 optionally includes, wherein the at least one processor is configured, when executing the second system virtual machine, to: verify the authenticity of the datafile based on the signature portion.

In Example 5, the subject matter of any one or more of Examples 1-4 optionally include, wherein the at least one processor is configured, when executing the second system virtual machine, to: receive a datafile representing a feature of a mobile device; determine that the feature is not already configured on the second system virtual machine; and establish a new process virtual machine for the feature.

In Example 6, the subject matter of any one or more of Examples 1-5 optionally include, wherein the at least one processor is configured, when executing the second system virtual machine, to: receive a datafile representing an update to a feature of a mobile device; determine that the feature is configured on the second system virtual machine as one of the at least one process virtual machines; and update the process virtual machine according to the update.

In Example 7, the subject matter of any one or more of Examples 1-6 optionally include, wherein the RTOS schedules execution of the at least one process virtual machine based on priority levels of respective process virtual machines of the at least one process virtual machine.

In Example 8, the subject matter of any one or more of Examples 1-7 optionally include, wherein the first system virtual machine further includes: a runtime configured to execute applications on behalf of a user.

Example 9 is a method of executing virtual machines on a system on a chip, the method comprising: executing a first system virtual machine on a first processing core of the system on a chip; executing a user downloaded application on the first processing core of the least one processor; executing a second system virtual machine on a second core of at least one processor, wherein the second system virtual machine includes at least one process virtual machine; and scheduling execution of the at least one process virtual machine on the second core of the at least one processor using a real-time operating system of the second virtual machine.

In Example 10, the subject matter of Example 9 optionally includes, wherein the at least one process virtual machine includes a modem configured as a process virtual machine.

In Example 11, the subject matter of Example 10 optionally includes, wherein executing the second system virtual machine on a second core of at least one processor includes: receiving a datafile including an update to the modem; and updating communication primitives of the modem based on data received in the datafile.

In Example 12, the subject matter of Example 11 optionally includes, wherein the datafile comprises a signature portion.

In Example 13, the subject matter of Example 12 optionally includes, wherein executing the second system virtual machine on a second core of at least one processor includes: verifying the authenticity of the datafile based on the signature portion.

In Example 14, the subject matter of any one or more of Examples 9-13 optionally include, wherein executing the second system virtual machine on a second core of at least one processor includes: receiving a datafile representing a feature of a mobile device; determining that the feature is not already configured on the second system virtual machine; and establishing a new process virtual machine for the feature.

In Example 15, the subject matter of any one or more of Examples 9-14 optionally include, wherein executing the second system virtual machine on a second core of at least one processor includes: receiving a datafile representing an update to a feature of a mobile device; determining that the feature is configured on the second system virtual machine as one of the at least one process virtual machines; and updating the process virtual machine according to the update.

In Example 16, the subject matter of any one or more of Examples 9-15 optionally include, wherein the RTOS schedules execution of process virtual machines of the at least one process virtual machine based on priority levels of the respective process virtual machines.

In Example 17, the subject matter of any one or more of Examples 9-16 optionally include, wherein the first system virtual machine further includes a runtime configured to execute applications on behalf of a user.

Example 18 is at least one machine-readable medium including instructions, which when executed by a machine, cause the machine to perform operations of any of the methods of Examples 10-17.

Example 19 is an apparatus comprising means for performing any of the methods of Examples 10-17.

Example 20 is a apparatus for executing virtual machines on a system on a chip, the apparatus comprising: means for executing a first system virtual machine on a first processing core of the system on a chip; means for executing a user downloaded application on the first processing core of the least one processor; means for executing a second system virtual machine on a second core of at least one processor, wherein the second system virtual machine includes at least one process virtual machine; and means for scheduling execution of the at least one process virtual machine on the second core of the at least one processor using a real-time operating system of the second virtual machine.

In Example 21, the subject matter of Example 20 optionally includes, wherein the at least one process virtual machine includes a modem configured as a process virtual machine.

In Example 22, the subject matter of Example 21 optionally includes, wherein the means for executing the second system virtual machine on a second core of at least one processor includes: means for receiving a datafile including an update to the modem; and means for updating communication primitives of the modem based on data received in the datafile.

In Example 23, the subject matter of Example 22 optionally includes, wherein the datafile comprises a signature portion.

In Example 24, the subject matter of Example 23 optionally includes, wherein the means for executing the second system virtual machine on a second core of at least one processor includes: means for verifying the authenticity of the datafile based on the signature portion.

In Example 25, the subject matter of any one or more of Examples 20-24 optionally include, wherein the means for executing the second system virtual machine on a second core of at least one processor includes: means for receiving a datafile representing a feature of a mobile device; means for determining that the feature is not already configured on the second system virtual machine; and means for establishing a new process virtual machine for the feature.

In Example 26, the subject matter of any one or more of Examples 20-25 optionally include, wherein the means for executing the second system virtual machine on a second core of at least one processor includes: means for receiving a datafile representing an update to a feature of a mobile device; means for determining that the feature is configured on the second system virtual machine as one of the at least one process virtual machines; and means for updating the process virtual machine according to the update.

In Example 27, the subject matter of any one or more of Examples 20-26 optionally include, wherein the RTOS schedules execution of process virtual machines of the at least one process virtual machine based on priority levels of the respective process virtual machines.

In Example 28, the subject matter of any one or more of Examples 20-27 optionally include, wherein the first system virtual machine further includes a runtime configured to execute applications on behalf of a user.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A system on a chip (SoC) for executing virtual machines, the SoC comprising:
at least one processor with at least one core; and
a storage device comprising a first system virtual machine configured to be executed on the at least one processor;
wherein the storage device further comprises a second system virtual machine configured to be executed by the at least one processor, the second system virtual machine including:
at least one process virtual machine;
a modem configured as one of the at least one process virtual machine; and
a real-time operating system (RTOS) to schedule execution of the at least one process virtual machine on the at least one processor.

2. The SoC of claim 1, wherein the at least one processor is configured, when executing the second system virtual machine, to:
receive a datafile including an update to the modem; and
update communication primitives of the modem based on data received in the datafile.

3. The SoC of claim 2, wherein the datafile comprises a signature portion.

4. The SoC of claim 3, wherein the at least one processor is configured, when executing the second system virtual machine, to:
verify the authenticity of the datafile based on the signature portion.

5. The SoC of claim 1, wherein the at least one processor is configured, when executing the second system virtual machine, to:
receive a datafile representing a feature of a mobile device;
determine that the feature is not already configured on the second system virtual machine; and
establish a new process virtual machine for the feature.

6. The SoC of claim 1, wherein the at least one processor is configured, when executing the second system virtual machine, to:
receive a datafile representing an update to a feature of a mobile device;
determine that the feature is configured on the second system virtual machine as one of the at least one process virtual machines; and
update the process virtual machine according to the update.

7. The SoC of claim 1, wherein the RTOS schedules execution of the at least one process virtual machine based on priority levels of respective process virtual machines of the at least one process virtual machine.

8. The SoC of claim 1, wherein the first system virtual machine further includes:
a runtime configured to execute applications on behalf of a user.

9. A method of executing virtual machines on a system on a chip, the method comprising:
executing a first system virtual machine on a first processing core of the system on a chip;
executing a user downloaded application on the first processing core of the at least one processor;
executing a second system virtual machine on a second core of at least one processor, wherein the second system virtual machine includes at least one process virtual machine; and
scheduling execution of the at least one process virtual machine on the second core of the at least one processor using a real-time operating system of the second virtual machine.

10. The method of claim 9, wherein the at least one process virtual machine includes a modem configured as a process virtual machine.

11. The method of claim 10, wherein executing the second system virtual machine on a second core of at least one processor includes:
receiving a datafile including an update to the modem; and
updating communication primitives of the modem based on data received in the datafile.

12. The method of claim 11, wherein the datafile comprises a signature portion.

13. The method of claim 12, wherein executing the second system virtual machine on a second core of at least one processor includes:
verifying the authenticity of the datafile based on the signature portion.

14. The method of claim 9, wherein executing the second system virtual machine on a second core of at least one processor includes:
receiving a datafile representing a feature of a mobile device;
determining that the feature is not already configured on the second system virtual machine; and
establishing a new process virtual machine for the feature.

15. The method of claim 9, wherein executing the second system virtual machine on a second core of at least one processor includes:
receiving a datafile representing an update to a feature of a mobile device;
determining that the feature is configured on the second system virtual machine as one of the at least one process virtual machines; and
updating the process virtual machine according to the update.

16. The method of claim 9, wherein the RTOS schedules execution of process virtual machines of the at least one process virtual machine based on priority levels of the respective process virtual machines.

17. The method of claim 9, wherein the first system virtual machine further includes a runtime configured to execute applications on behalf of a user.

18. At least one machine-readable medium including instructions, which when executed by a machine, cause the machine to perform operations comprising:
executing a first system virtual machine on a first processing core of the system on a chip;
executing a user downloaded application on the first processing core of the at least one processor;
executing a second system virtual machine on a second core of at least one processor, wherein the second system virtual machine includes at least one process virtual machine; and
scheduling execution of the at least one process virtual machine on the second core of the at least one processor using a real-time operating system of the second virtual machine.

19. The at least one machine-readable medium of claim 18, wherein the at least one process virtual machine includes a modem configured as a process virtual machine.

20. The at least one machine-readable medium of claim 19, wherein the operation of executing the second system virtual machine on a second core of at least one processor includes operations comprising:
receiving a datafile including an update to the modem; and
updating communication primitives of the modem based on data received in the datafile.

21. The at least one machine-readable medium of claim 20, wherein the datafile comprises a signature portion.

22. The at least one machine-readable medium of claim 21, wherein the operation of executing the second system virtual machine on a second core of at least one processor includes an operation of:
verifying the authenticity of the datafile based on the signature portion.

23. The at least one machine-readable medium of claim 18, wherein the operation of executing the second system virtual machine on a second core of at least one processor includes operations comprising:
receiving a datafile representing a feature of a mobile device;
determining that the feature is not already configured on the second system virtual machine; and
establishing a new process virtual machine for the feature.
